(19) United States
(12) Patent Application Publication
(10) Pub. No.: US 2018/0372207 A1
(43) Pub. Date: Dec. 27, 2018

(54) MAIN SHAFT BEARING ASSEMBLY FOR A VEHICLE GEARBOX

(71) Applicant: Baker, Inc., Haslett, MI (US)

(72) Inventors: Bert E. Baker, Jr., Williamston, MI (US); Chad W. Behrendt, Fowler, MI (US)

(21) Appl. No.: 16/020,889

(22) Filed: Jun. 27, 2018

Related U.S. Application Data
(60) Provisional application No. 62/525,285, filed on Jun. 27, 2017.

(51) Int. Cl. F16H 57/021; F16C 19/36

(52) U.S. Cl. CPC F16H 57/021; F16C 2326/06; F16C 19/364

(57) ABSTRACT

A main shaft bearing assembly for use in a sequential gearbox transmission. The main shaft bearing assembly includes a main shaft having an input spline that extends out of the transmission housing and a main shaft gear positioned within the transmission housing. A main drive gear is concentrically aligned with and positioned around the main shaft. The main drive gear has a cylindrical section that extends partially out of the transmission housing and a gear section positioned within the transmission housing. There is a roller bearing assembly for providing a bearing surface between the transmission housing and the main drive gear. The tapered roller bearing assembly is concentrically aligned with the main shaft and the main drive gear, and the tapered roller bearing assembly is positioned around the cylindrical section of the main drive gear. The tapered roller bearing assembly has a plurality of cylindrical rollers which are preferably tapered.

### CROSS REFERENCE TO RELATED APPLICATION

This application claims the benefit of U.S. Provisional Application 62/525,285, which was filed on Jun. 27, 2017, the entire disclosure of which is hereby incorporated by reference.

### BACKGROUND OF THE INVENTION

### 1. Field of the Invention

The present invention pertains to a main shaft bearing assembly for a vehicle gearbox. More particularly, the present invention pertains to a main shaft bearing assembly for use in a sequential transmission gearbox having a tapered roller bearing for rotatably securing a main drive gear to the transmission housing.

### 2. Description of the Prior Art

Vehicular transmissions that utilize sequential gearboxes are well-known and commonly used, and particularly for use with motorcycles. Although improvements to sequential gearboxes continue to be made, the basic design and components of sequential gearboxes has remained substantially unchanged for many years.

As understood by those having ordinary skill in the art, a sequential gearbox transmission includes a main shaft assembly and a counter shaft assembly which are aligned generally parallel to one another. The main shaft assembly includes a main shaft having a main shaft input spline that extends out of the transmission housing. The main shaft input spline receives rotational driving input from the engine via a clutch.

The main shaft assembly also includes an output drive assembly for transferring power from the transmission to the rear wheel(s). The output drive assembly is connected to a main drive gear which is coaxially aligned with, and positioned around, the main shaft. The main shaft and the main drive gear are not rotatably locked to each other. The difference in rotational velocity between the main shaft and the main drive gear is variably altered depending upon the gear ratio of the gears that are selectively engaged to transfer power from the main shaft to the counter shaft.

Both the main shaft assembly and the counter shaft assembly have a plurality of gears that are positioned on, and coaxially aligned with, the respective main shaft or counter shaft. Some of the gears are freely rotatable with respect to the main shaft and/or counter shaft, and some of the gears are rotatably locked to the main shaft and/or counter shaft, such as by being splined to the respective shaft.

There are also a plurality of dog rings, or dog gears, coaxially positioned on the main shaft and counter shaft. The dog gears each include a plurality of dogs, or lugs, that extend outwardly from a side of the gear.

As understood by those having ordinary skill in the art, each of the dog gears is connected to a fork, which is in turn connected to a shift drum. The shift drum is rotated by a vehicle operator through a series of shift linkages, which in turn sequentially moves the dog gears along the main shaft and/or counter shaft. As the dog gears are moved sequentially, the dog gears engage and disengage with the various gears on the main shaft and the counter shaft. Each rotational position of the shift drum results in a different sequential set of gears that rotatably connect the main shaft to the counter shaft.

The counter shaft assembly includes an output gear that is rotatably locked thereto, and which is in constant mesh with the main drive gear.

In general, power is delivered to the sequential gearbox via the input spline which rotates the main shaft. The main shaft is rotatably locked to a set of interconnected gears, one of which is on the main shaft and one of which is on the counter shaft (the particular set of gears being selectively determined by the dog gear positioning). The interconnected gear positioned on the counter shaft is rotatably locked to the counter shaft. The counter shaft transfers the rotational energy from the interconnected gear to the output gear. The output gear is rotatably in constant mesh with the main drive gear. In turn, the main drive gear rotatably drives the output drive assembly which then transfers the rotational energy to the vehicle's drive wheel(s).

It is understood that a significant amount of torque passes through a sequential gearbox. The main shaft and counter shaft are rotatably held in place by bearings on the ends thereof. As shown in FIG. 1, which is a drawing showing a cross-sectional view of a sequential gearbox in the prior art, the ends of the main shaft and the counter shaft are held in position by ball bearings B, such as self-aligning bearings. It has been determined that these types of bearings are somewhat prone to failure. This is particularly true for the bearings that hold the main shaft in place near the end that extends out of the transmission housing which receives and transfers power from the engine.

Furthermore, vehicle owners sometimes make aftermarket modifications to their vehicle's engine, which can substantially increase the power of the engine. These modifications can increase the horsepower of the engine by a factor of two, three, or even four over the stock horsepower. These power modifications can also lead to premature failure of the transmission, including specifically a failure of the bearings holding the main shaft and counter shaft in place in the transmission housing. And as mentioned above, this is particularly true for the end of the main shaft that extends out of the transmission housing and is responsible for transmitting power from the engine to the vehicle's wheel(s).

Thus, there remains a need for a more robust sequential gearbox that is less susceptible to failure when the power generated by the engine is increased.

The present invention, as detailed hereinbelow, seeks to improve upon existing sequential gearboxes by providing a sequential gearbox having a more robust mechanism for rotatably securing the main shaft to the transmission housing.

### SUMMARY OF THE INVENTION

The present invention provides a main shaft bearing assembly which includes a main shaft, a main drive gear, and at least one tapered roller bearing assembly. The main drive gear includes a bored-through cylindrical section and a gear section. The cylindrical section includes a splined outer surface at a first end, and a toothed gear at a second end, the toothed gear having a diameter that is greater than that of the cylindrical section.

The tapered roller bearing assembly is assembled around the cylindrical section of the main drive gear, and is located axially on the main drive gear between the splined outer surface and the gear section. The tapered roller bearing assembly includes an inner ring (or cone) having an inner raceway, a plurality of tapered cylindrical rollers which are seated partially within the inner raceway, and a ring-shaped cup which is positioned around the tapered rollers and the cone. The cup and the cone encapsulate the rollers therebetween.

Optionally, there are provided two angularly-opposed tapered roller bearing assemblies.

For a more complete understanding of the present invention, reference is made to the following detailed description and accompanying drawings. In the drawings, like reference characters refer to like parts throughout the views in which:

### BRIEF DESCRIPTION OF THE DRAWINGS

FIG. 1 is a sectional view of a sequential transmission gearbox found in the prior art;

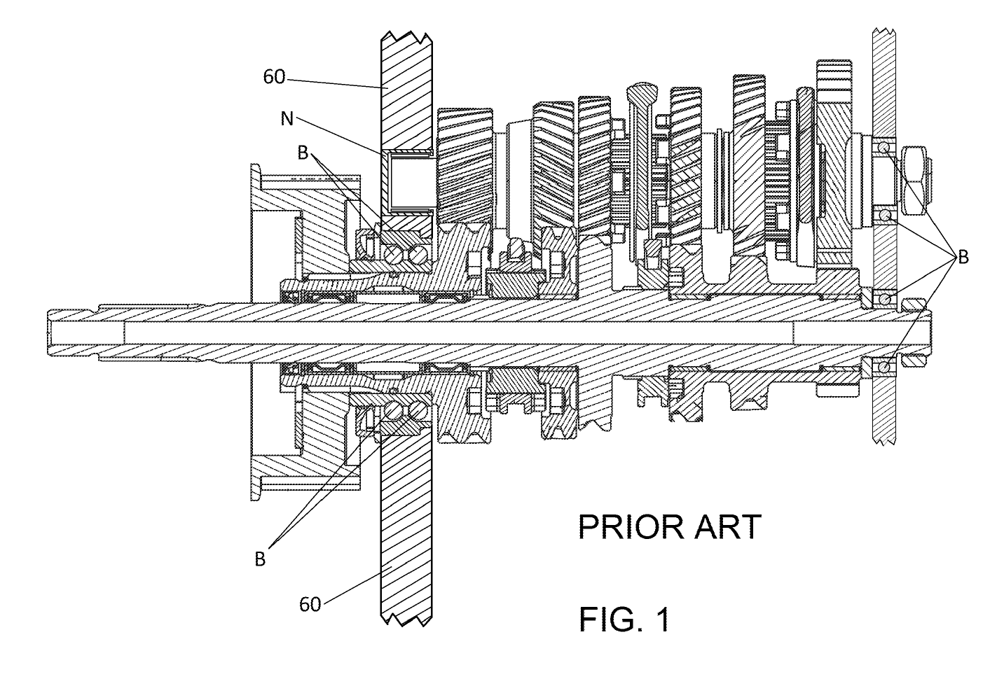

FIG. 2 is a side view of an exemplary vehicle that utilizes a sequential gearbox, and in particular, FIG. 2 shows a side view of a motorcycle;

FIG. 3 is a front view of a transmission assembly, an engine assembly, and a primary assembly;

FIG. 4 is a perspective view of a transmission assembly, and a final drive loop member and a wheel drive member;

FIG. 5 is a bottom side view of a main shaft assembly and a counter shaft assembly;

FIG. 6 is a perspective view of the main shaft assembly and the counter shaft assembly, and the tapered roller bearing assembly being shown in half section;

FIG. 7 is a perspective view of a transmission cartridge including the main shaft assembly, the counter shaft assembly, the shift assembly, and a cartridge wall which forms a portion of the transmission housing once fully assembled into the transmission;

FIG. 8 is a perspective view of a main shaft bearing assembly including the main shaft, the main drive gear, and the tapered roller bearing assembly;

FIG. 9 is an additional view of the perspective view of the main shaft bearing assembly from FIG. 8, with the tapered roller bearing assembly shown in half section; and

FIG. 10 is an exploded view of the main drive gear and the tapered roller bearing.

### DETAILED DESCRIPTION OF A PREFERRED EMBODIMENT

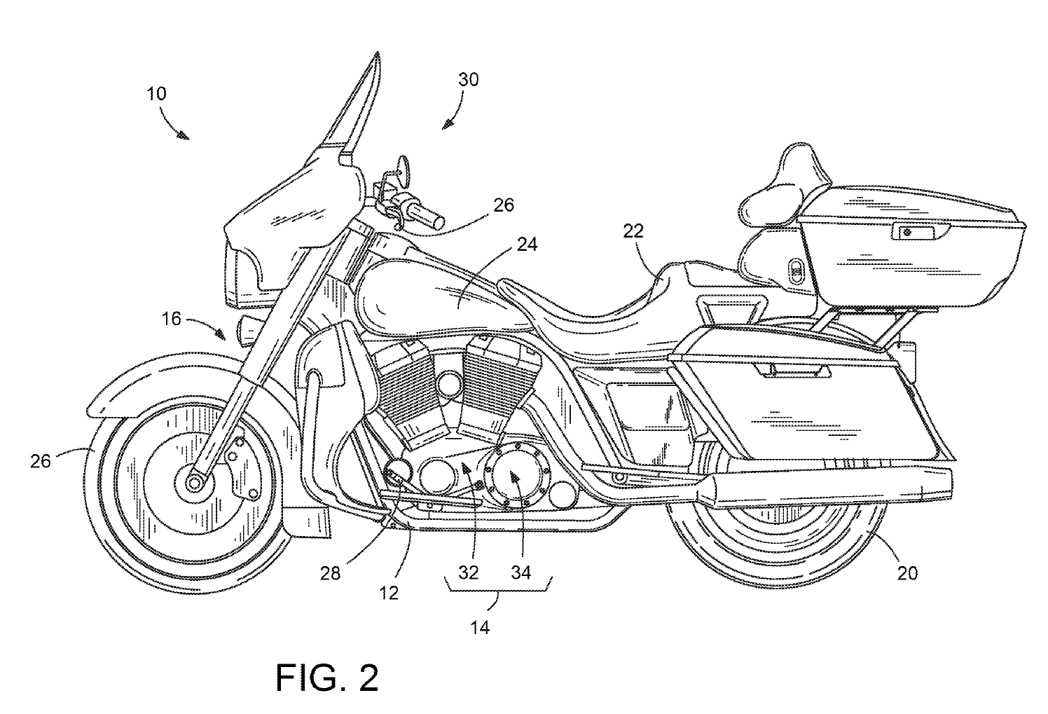

In accordance with the present invention, and as shown generally in FIG. 2, there is provided a vehicle 10 according to one embodiment of the invention. In the illustrated embodiment, the vehicle 10 is a motorcycle. The motorcycle 10 includes a frame 12, an engine/transmission unit 14, a front fork assembly 16, a front wheel 18, a rear wheel 20, a seat 22, a fuel tank 24, a hand-operated clutch lever 26, and a foot-operated shifter 28. The frame 12 supports the engine/transmission unit 14, the front fork assembly 16, the seat 22, and the fuel tank 24. The front fork assembly 16 is pivotally coupled to the frame 12 and supports the front wheel 18 and a handle bar assembly 30 upon which the hand-operated clutch lever 26 is mounted. The seat 22 is coupled to the frame 12 behind the front fork assembly 16 and is configured for supporting a rider. The foot-operated shifter 28 is coupled to the engine/transmission unit 14 so that a user can operate the shifter 28 with their foot to select transmission gear ratios as described in further detail below. The fuel tank 24 is supported by the frame 12 and provides fuel to an engine 32 (e.g., internal combustion engine) of the engine/transmission unit 14 during operation of the motorcycle 10.

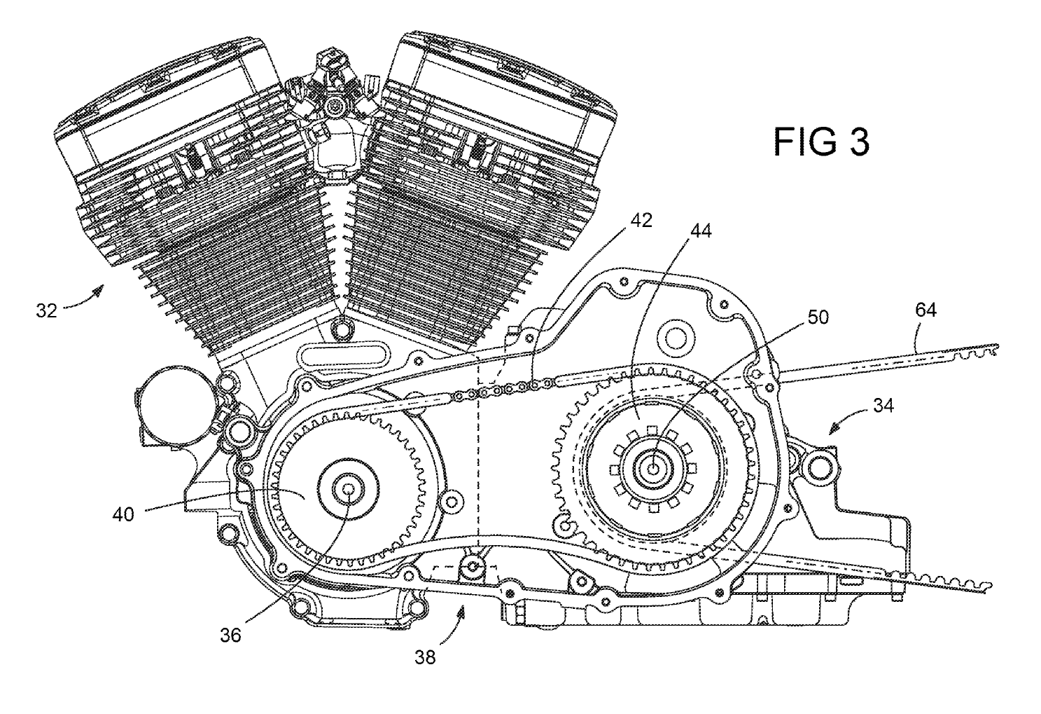

The engine/transmission unit 14 is coupled to the frame 12 beneath the seat 22 and between the front wheel 18 and the rear wheel 20 of the motorcycle 10. In the illustrated embodiment, the engine 32 of the engine/transmission unit 14 is a V-twin engine, but other engine configurations can be used herewith. The engine 32 drives the rear wheel 20 through a transmission assembly 34 of the engine/transmission unit 14. With reference to FIG. 3, the engine 32 includes an output shaft, or crankshaft 36, coupled to the transmission assembly 34 via a primary assembly 38. The primary assembly 38 includes a drive member 40 (e.g., a sprocket, a gear, a pulley, or the like) mounted on the crankshaft 36 for driving a primary loop member (e.g., a chain, a belt, or the like).

The primary assembly 38 further includes a clutch pack 44 including a clutch pack input driven by the primary loop member 42. The clutch pack 44 includes a clutch pack output coupled to the transmission assembly 34. The clutch pack 44 is biased to an engaged state to transmit rotational power. The power at the engine crankshaft 36 is transferred to the transmission assembly 34 via the clutch pack 44. The clutch pack 44 is selectively moved to a disengaged state by the user via the hand-operable clutch lever 26. The clutch pack 44 is operable to disengage the transmission assembly 34 from the engine 32 when the hand-operated clutch lever 26 is pulled, and allows for shifting events to occur in the transmission assembly 34 in response to a user actuating the foot-operated shifter 28.

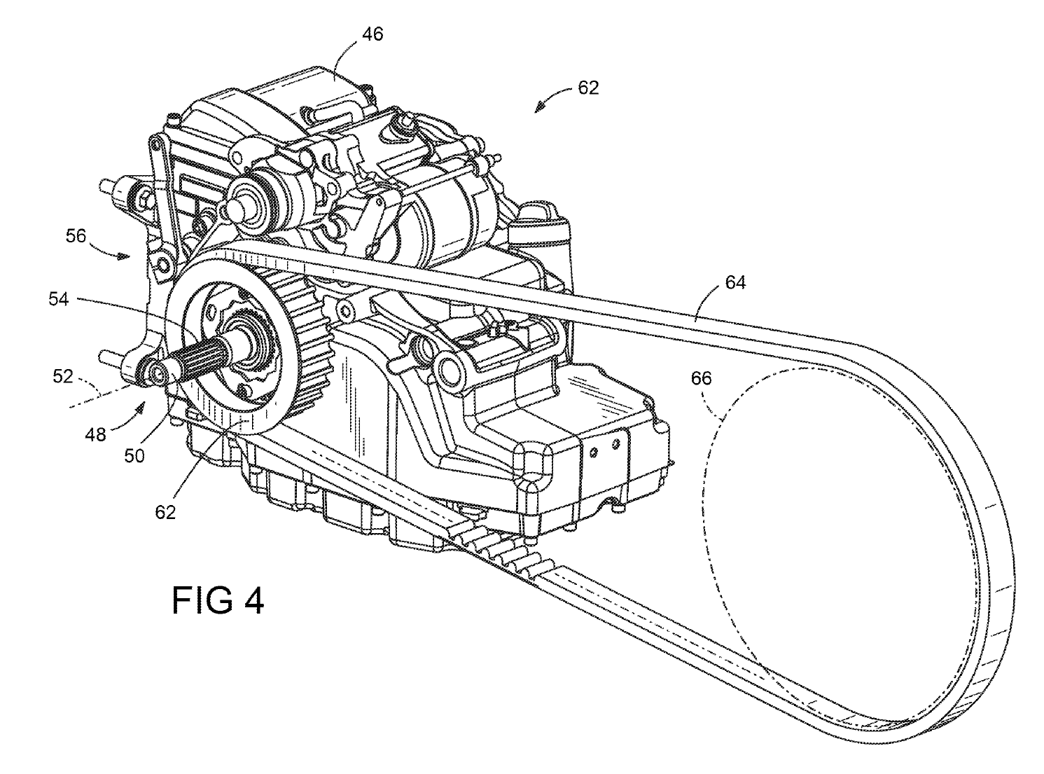

As shown in FIG. 4, the transmission assembly 34 includes a transmission housing 46 and a main shaft assembly 48. The main shaft assembly 48 includes a main shaft 50 defining a main shaft rotational axis 52. The main shaft 50 includes a main shaft input spline 54, or transmission input, extending out of the transmission housing 46 and coupled to the clutch pack 44 to selectively receive driving input from the engine 32. In addition, the transmission assembly 34 includes an output drive assembly 56 supported on the main shaft 50 including a main drive gear 58 extending through a wall 60 of the transmission housing 46. The output drive assembly 56 also includes an output drive member 62 (e.g. a sprocket, a gear, a pulley, or the like) that is positioned outside the transmission housing 46 and which is secured to the main drive gear 58. Accordingly, the rotating main drive gear 58 rotates the output drive member 62, which in turn transfers rotational energy to drive the rear wheel 20 via the final drive loop member 64 (e.g., a chain, a belt, or the like). The final drive loop member 64 is rotatably coupled to a wheel drive member 66 (e.g., a sprocket, gear, rear axle assembly, etc.), which is secured to the rear wheel 20.

It is to be understood that the present invention can be used with any suitable type of sequential gearbox. The following description is directed to an exemplary type of sequential gearbox, and therefore the following discussion of the various gears and operation of shifting gears should not be limiting on the scope of the invention in any manner

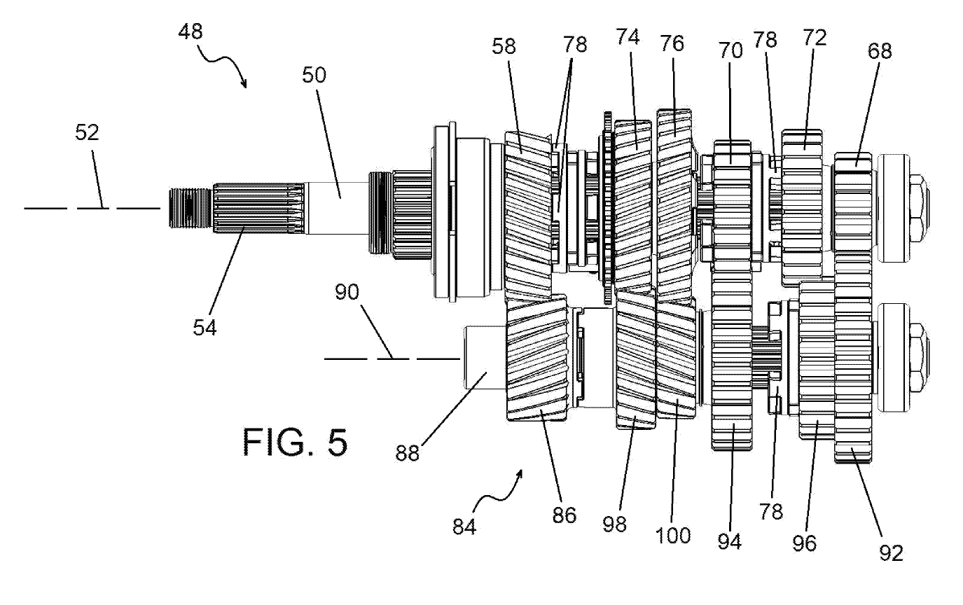

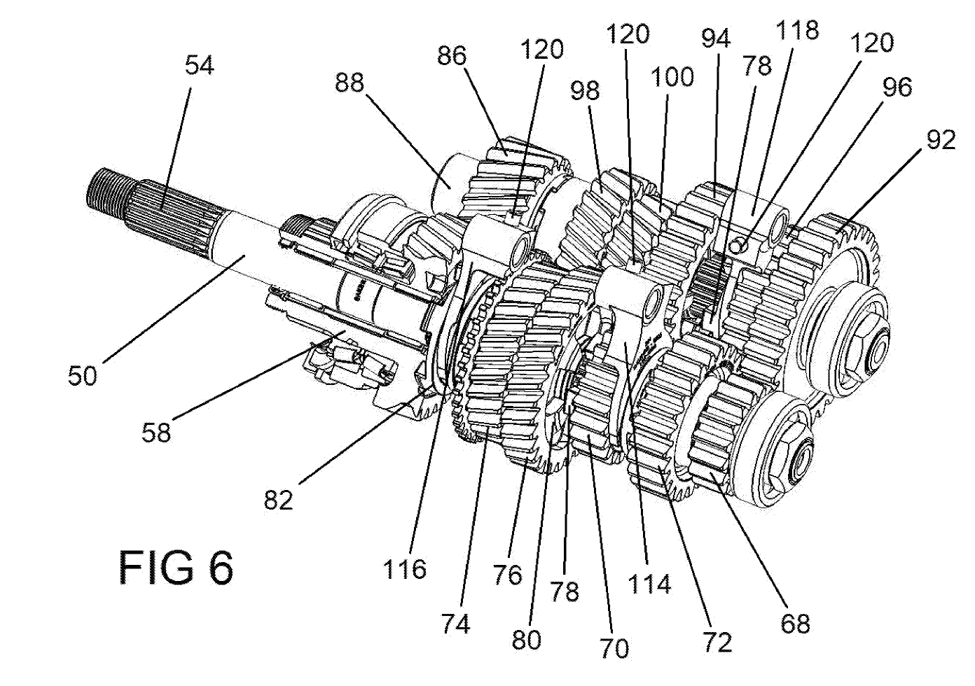

Referring now to FIGS. 5 and 6, the main shaft assembly 48 includes a main shaft gear 68 which is rotationally locked to the main shaft 50. The main shaft assembly 48 also includes a second main shaft gear 70, a third main shaft gear 72, a fourth main shaft gear 74, and a sixth main shaft gear 76. In this embodiment, the third main shaft gear 72, the fourth main shaft gear 74, and the sixth main shaft gear 76 are coaxially positioned on the main shaft 50, but these gears 72, 74, 76 are not rotationally locked to the main shaft 50 and they can rotate freely with respect to the main shaft 50.

Conversely, the second main shaft gear 70 is splined to the main shaft 50 such that the second main shaft gear 70 is rotationally locked to the main shaft 50. The second main shaft gear 70 can slide axially back-and-forth along the main shaft 50. The second main shaft gear 70 has a plurality of lugs 78 extending laterally outwardly from each side thereof. The third main shaft gear 72 and the sixth main shaft gear 76 each have a plurality of pockets 80 for receiving, and engaging with, the lugs 78 on the second main shaft gear 70. Thus, the second main shaft gear 70 can slide axially along the main shaft 50 to selectively engage or disengage rotationally with either the third main shaft gear 72 or the sixth main shaft gear 76.

In addition, there is also provided a dog clutch 82 which is splined to, and rotationally engaged with, the main shaft 50. Similar to the second main shaft gear 70, the dog clutch 82 can slide axially along the main shaft 50. The dog clutch 82 has a plurality of lugs 78 extending axially, or laterally, outwardly from each side thereof. The fourth main shaft gear 74 and the main drive gear 58 each have a plurality of pockets 80 for receiving, and engaging with, the lugs 78 on the dog clutch 82. Thus, the dog clutch 82 can slide axially along the main shaft 50 to selectively engage or disengage rotationally with either the fourth main shaft gear 74 or the main drive gear 58.

The counter shaft assembly 84, which is axially aligned with and spaced apart from the main shaft assembly 48, includes an output gear 86 which is rotationally locked to the counter shaft 88. The counter shaft 88 defines a counter shaft rotational axis 90. The output gear 86 is also in constant engagement with the main drive gear 58. The counter shaft 88 also includes a first counter shaft gear 92, a second counter shaft gear 94, a third counter shaft gear 96, a fourth counter shaft gear 98, and a sixth counter shaft gear 100. In this embodiment, the first counter shaft gear 92 and the second counter shaft gear 94 are coaxially positioned on the counter shaft 88, but these gears 92, 94 are not rotationally locked to the counter shaft 88 and they can rotate freely with respect to the counter shaft 88. The fourth counter shaft gear 98 and the sixth counter shaft gear 100 are rotationally fixed to the counter shaft 88, similar to the output gear 86.

Conversely, the third counter shaft gear 96 is splined to the counter shaft 88 such that the third counter shaft gear 96 is rotationally locked to the counter shaft 88, but the third counter shaft gear 96 can slide axially back-and-forth along the counter shaft 88. The third counter shaft gear 96 has a plurality of lugs 78 extending laterally outwardly from each side thereof. The first counter shaft gear 92 and the second counter shaft gear 94 each have a plurality of pockets 80 for receiving, and engaging with, the lugs 78 on the third counter shaft gear 96. Thus, the third counter shaft gear 96 can slide axially along the counter shaft 88 to selectively engage or disengage rotationally with either the first counter shaft gear 92 or the second counter shaft gear 94.

As shown in the drawings, the following respective pairs of gears on the main shaft 50 and the counter shaft 88 are rotationally engaged with each other: the main drive gear 58 and the output gear 86; the main shaft gear 68 and the first counter shaft gear 92; the second main shaft gear 70 and the second counter shaft gear 94; the third main shaft gear 72 and the third counter shaft gear 96; the fourth main shaft gear 74 and the fourth counter shaft gear 98; and the sixth main shaft gear 76 and the sixth counter shaft gear 100. As discussed below, the axial positioning of the second main shaft gear 70, the third counter shaft gear 96, and the dog clutch 82 determine which gears transfer power from the main shaft 50 to the main drive gear 58.

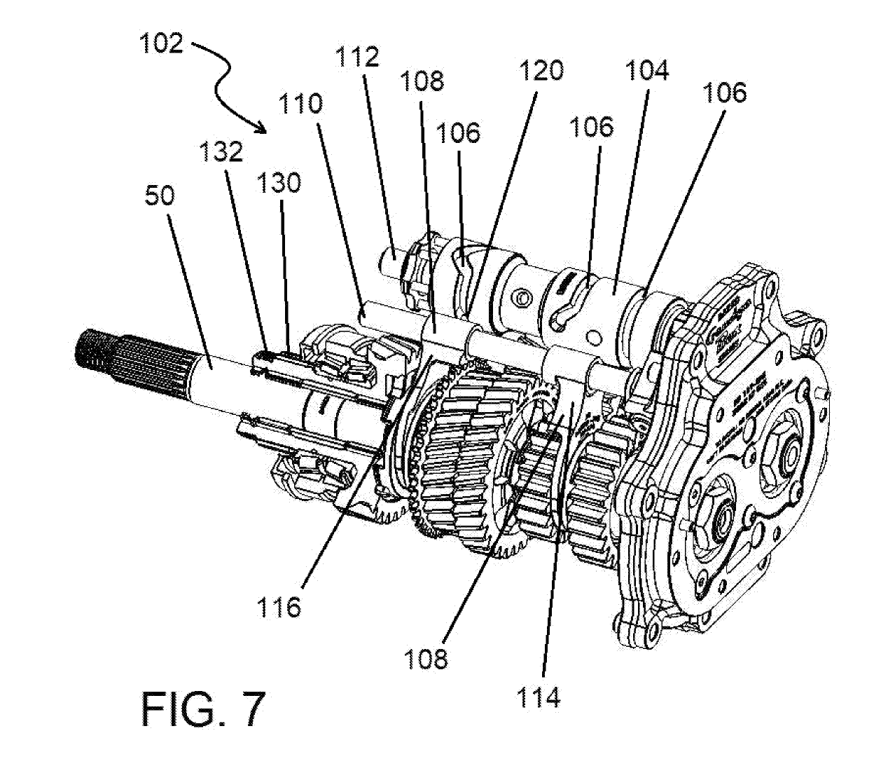

As shown best in FIGS. 6 and 7, the shift assembly 102 is positioned proximate both the main shaft assembly 48 and the counter shaft assembly 84, and includes a shift drum 104 coupled to the foot shifter 28 via a linkage (not shown). The shift drum 104 is substantially cylindrical and includes a plurality of curved or straight tracks 106 formed in the outer-periphery thereof. A plurality of shift forks 108 of the shift assembly 102 are supported on at least one shift fork rod mounted proximate to the shift drum 104 and substantially parallel to the axes 52,90. In the embodiment shown, there is a first shift fork rod 110 which supports a first shift fork 114 and a second shift fork 116. The first shift fork 114 is engaged with the second main shaft gear 70, and the second shift fork 116 is engaged with the dog clutch 82. There is also provided a second shift fork rod 112 that supports a third shift fork 118 which is engaged with the third counter shaft gear 96. The shift forks 108 are slidably coupled to the shift fork rods 110, 112, and each of the shift forks 108 includes a dowel pin 120 which is seated in a respective track 106 in the shift drum 104. As the shift drum 104 rotates, the dowel pins 120 move through the tracks 106, and the shift forks 108 are thus directed axially back-and-forth along the shift fork rods 110, 112 in a predetermined sequence.

In operation, driving power is provided from the engine 32 to the transmission assembly 34 via the primary loop member 42, and through a power transmission path of the transmission assembly 34. Finally, from the transmission assembly 34, power is supplied to the rear wheel 20 via the final drive loop member 64, propelling the motorcycle 10 forward. The transmission assembly 34 is operable to provide a plurality of gear ratios. The gear ratios change the rotational speed of the engine crankshaft 36 to a suitable speed to be applied to the rear wheel 20. Different gear ratios are established depending on which gears are locked for rotation with the main shaft 50 and the counter shaft 88 as dictated by the shift assembly 102 and the sequential action of the footshifter 28. For example, in response to user input of the foot shifter 28, the linkage (not shown) rotates the shift drum 104. Corresponding to the rotation of the shift drum 104, the tracks 106 force the shift forks 108 to slide along the rods 110, 112. The sliding of the shift forks 108 moves the second main shaft gear 70, third counter shaft gear 96, or dog clutch 82 into or out of engagement with corresponding gears in a predetermined pattern to establish a first gear, second gear, third gear, fourth gear, fifth gear, and sixth gear (overdrive).

To engage first gear, the third counter shaft gear 96 slides axially adjacent to the first counter shaft gear 92. The lugs 78 on the third counter shaft gear 96 engage with the pockets 80 in the first counter shaft gear 92, thus rotationally locking the two gears together. In this configuration, power transfers from the main shaft 50 to the main shaft gear 68, through the first counter shaft gear 92, to the third counter shaft gear 96 which is rotationally-engaged with the first counter shaft gear 92, then to the counter shaft 88 and the output gear 86, and then to the main drive gear 58.

To engage neutral, or alternatively, to disengage the main shaft 50 from the main drive gear 58, all three of the third counter shaft gear 96, the second main shaft gear 70, and the dog clutch 82 are rotationally disengaged from any adjacent gears. Thus, power from the main shaft 50 transfers to the main shaft gear 68 and then to the first counter shaft gear 92, which spins freely in this configuration.

To engage second gear, the third counter shaft gear 96 slides axially adjacent against the second counter shaft gear 94. The lugs 78 on the third counter shaft gear 96 engage with the pockets 80 in the second counter shaft gear 94, thus rotationally locking the two gears together. In this configuration, power transfers from the main shaft 50 to the second main shaft gear 70, to the second counter shaft gear 94 which is rotationally-engaged with the third counter shaft gear 96, then to the counter shaft 88 and the output gear 86, and then to the main drive gear 58.

To engage third gear, the third counter shaft gear 96 slides to disengage with the second counter shaft gear 94. The second main shaft gear 70 slides axially adjacent against the third main shaft gear 72. The lugs 78 on the second main shaft gear 70 engage with the pockets 80 in the third main shaft gear 72, thus rotationally locking the two gears together. In this configuration, power transfers from the main shaft 50 to the second main shaft gear 70, to the third main shaft gear 72 which is rotationally-engaged with the second main shaft gear 70, then to the third counter shaft gear 96, to the counter shaft 88 and the output gear 86, and then to the main drive gear 58.

To engage fourth gear, the second main shaft gear 70 disengages from the third main shaft gear 72. The dog clutch 82, which is splined to the main shaft 50, slides and rotationally engages with the fourth main shaft gear 74. The lugs 78 on the dog clutch 82 engage with the pockets 80 in the fourth main shaft gear 74. Power is transferred from the main shaft 50 to the dog clutch 82, and then to the fourth main shaft gear 74, on to the fourth counter shaft gear 98, through the counter shaft 88 to the output gear 86, and then to the main drive gear 58.

To engage fifth gear, the dog clutch 82 disengages with the fourth main shaft gear 74, and slides adjacent to the main drive gear 58. The lugs 78 in the dog clutch 82 engage with the pockets 80 in the main drive gear 58, thereby rotationally locking the main shaft 50 to the main drive gear 58, and resulting in a gear ratio of 1:1. Power is transferred from the main shaft 50 to the dog clutch 82, and then to the main drive gear 58.

To engage sixth gear, which is an overdrive gear, the dog clutch 82 disengages from the main drive gear 58. The second main shaft gear 70 slides against and engages with the sixth main shaft gear 76. Power is transferred from the main shaft 50 to the second main shaft gear 70, to the sixth main shaft gear 76, to the sixth counter shaft gear 100, through the counter shaft 88 to the output gear 86, and then to the main drive gear 58.

It will be appreciated by one having ordinary skill in the art that combinations of gears engaged or disengaged create a power transmission path from the main shaft 50 to the output drive assembly 56 to create different gear ratios. The shift forks 108 are engaged with the corresponding tracks 106 on the shift drum 104 so that rotation of the shift drum 104 changes the shift assembly 102 from one arrangement representing one gear ratio to another. The path of power through the transmission assembly 34 is thus selectively established from the main shaft 50 to the counter shaft 88 through a meshed gear pair of one on the gears of the main shaft 50 and one of the gears on the counter shaft 88. From the counter shaft 88, the power transmission path continues to the output drive assembly 56 through a meshed gear pair of the output gear 86 of the counter shaft 88 and the main drive gear 58 of the output drive assembly 56 (with the exception being fifth gear in which power does not transfer through the counter shaft 88). The power transmission path shown in FIGS. 5 and 6 represents the first gear configuration, although other gear ratio configurations are possible but are not all shown for the sake of brevity.

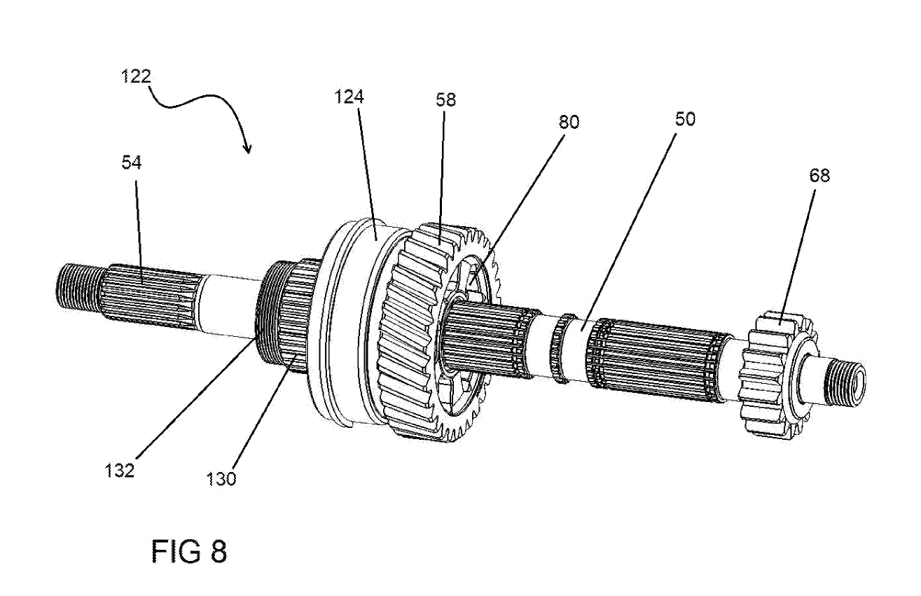

Turning to FIGS. 8-10, the main shaft assembly 48 includes a main shaft bearing assembly 122 having the main shaft 50, the main drive gear 58, and at least one tapered roller bearing assembly 124. The main drive gear 58 includes a bored-through cylindrical section 126 and a gear section 128. The main drive gear 58 and the main shaft 50 are concentrically aligned with one another, and the main shaft 50 extends through a bored-through center of the main drive gear 58. The main drive gear 58 and the main shaft 50 are configured to rotate freely of one another, and there is provided a bearing surface therebetween such as a needle bearing. The cylindrical section 126 includes a splined outer surface 130 and an externally-threaded end 132 which permits the main drive gear 58 to be secured to the output drive assembly 56. The gear section 128 has an enlarged diameter and is toothed for engagement with the output gear 86 on the counter shaft 88.

The tapered roller bearing assembly 124 includes an inner ring, or cone 134, having an inner raceway 136, a plurality of tapered rollers 140 which are seated partially within the inner raceway 136, and a ring-shaped cup 138 which is positioned around the tapered rollers 140 and the cone 134. The cone 134 has an inner cylindrical through-hole for receiving, and surrounding, the cylindrical section 126 of the main drive gear 58. The cone 134 also has an angled, or tapered, outer circumferential surface. The cup 138 has a cylindrical outer surface, and an angled, or tapered, inner circumferential surface. The cup 138 and the cone 134 cooperatively encapsulate the rollers 140 therebetween. In addition, a roller cage 142 is also provided to position the rollers 140 within the raceway 136. The roller cage 142 is relatively thin and conical in shape, and includes a plurality of generally rectangular cut-outs along its entire length. The rollers 140 are positioned within the cut-outs. In addition, the rollers 140 are generally cylindrical in shape, and preferably are tapered and having a larger diameter at one end than the opposed end. The tapered roller bearing assembly 124 is positioned around the cylindrical section 126 of the main drive gear 58, and is located axially on the main drive gear 58 between the splined outer surface 136 and the gear section 128.

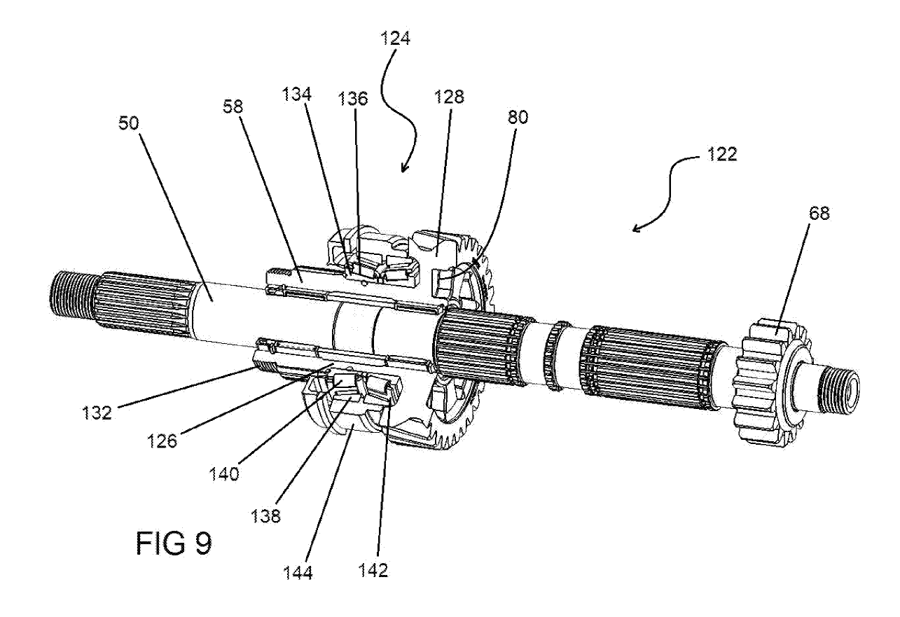

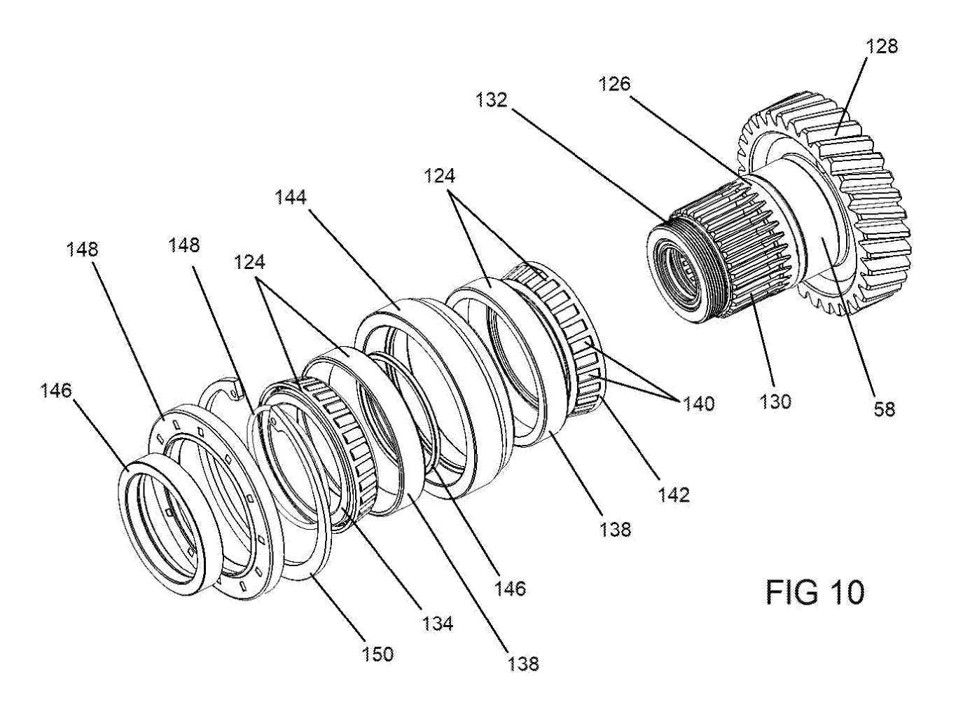

Preferably, and as shown in FIGS. 9 and 10, there are provided two angularly-opposed tapered roller bearing assemblies 124.

FIG. 10 shows an exploded view of the tapered roller bearing assembly 124, the main drive gear 58, and various other components. For example, there is also provided a ring-shaped bearing case 144 which surrounds the cup 138. The bearing case 144 is mounted within the wall 60 of the transmission housing 46, and provides an attachment point for the tapered roller bearing assembly 124 to the transmission housing wall 60. There are also provided several spacers 146, seals 148, and a snap ring 150 for assembling the tapered roller bearing assembly 124 onto the main drive gear 58. The tapered roller bearing assembly 124 provides a stronger and more robust bearing surface between the wall 60 of the transmission housing 46 and the main drive gear 58 which is capable of withstanding large amount of force.

According to the invention described above, a sequential gearbox is provided which has a more robust bearing surface for rotatably securing the main shaft and the main drive gear to the transmission housing.

It should be understood that the foregoing description is only illustrative of the aspects of the disclosed embodiments. Various alternatives and modifications can be devised by those skilled in the art without departing from the aspects of the disclosed embodiments. Accordingly, the aspects of the disclosed embodiments are intended to embrace all such alternatives, modifications, and variances that fall within the scope of the appended claims. Further, the mere fact that different features are recited in mutually different dependent or independent claims does not indicate that a combination of these features cannot be advantageously used, such as a combination remaining within the scope of the aspects of the disclosed embodiments.

What is claimed is:

1. A main shaft bearing assembly for use in a transmission assembly including a transmission housing, the main shaft bearing assembly comprising:
a main shaft having a main shaft input spline that extends out of the transmission housing, and a main shaft gear positioned within the transmission housing;
a main drive gear that is concentrically aligned with, and positioned around, the main shaft, the main drive gear having a bored-through cylindrical section that extends at least partially out of the transmission housing, and a gear section that is positioned within the transmission housing; and
a tapered roller bearing assembly for providing a bearing surface between a wall of the transmission housing and the main drive gear, the tapered roller bearing assembly being concentrically aligned with the main shaft and the main drive gear, and the tapered roller bearing assembly being positioned around the bored-through cylindrical section of the main drive gear, the tapered roller bearing assembly further having a plurality of cylindrical rollers.

2. The main shaft bearing assembly of claim 1 having two tapered roller bearing assemblies which are angularly-opposed to one another.

3. The main shaft bearing assembly of claim 2 configured for use in a transmission assembly having a sequential gearbox.

4. The main shaft bearing assembly of claim 2 wherein the rollers are tapered having a larger diameter at a first end than a second end.

5. The main shaft bearing assembly of claim 4 wherein the tapered roller bearing assembly includes a cone having an inner cylindrical through-hole and a tapered outer circumferential surface, a cup having a cylindrical outer surface and a tapered inner through-hole, and the cup and the cone cooperatively encapsulate the rollers therebetween.

6. The main shaft bearing assembly of claim 5 configured for use in a transmission assembly having a sequential gearbox.

7. The main shaft bearing assembly of claim 2 wherein the tapered roller bearing assembly includes a cone having an inner cylindrical through-hole and a tapered outer circumferential surface, a cup having a cylindrical outer surface and a tapered inner through-hole, and the cup and the cone cooperatively encapsulate the rollers therebetween.

8. The main shaft bearing assembly of claim 1 wherein the rollers are tapered having a larger diameter at a first end than a second end.

9. The main shaft bearing assembly of claim 8 wherein the tapered roller bearing assembly includes a cone having an inner cylindrical through-hole and a tapered outer circumferential surface, a cup having a cylindrical outer surface and a tapered inner through-hole, and the cup and the cone cooperatively encapsulate the rollers therebetween.

10. The main shaft bearing assembly of claim 9 configured for use in a transmission assembly having a sequential gearbox.

11. The main shaft bearing assembly of claim 8 configured for use in a transmission assembly having a sequential gearbox.

12. The main shaft bearing assembly of claim 1 wherein the tapered roller bearing assembly includes a cone having an inner cylindrical through-hole and a tapered outer circumferential surface, a cup having a cylindrical outer surface and a tapered inner through-hole, and the cup and the cone cooperatively encapsulate the rollers therebetween.

13. The main shaft bearing assembly of claim 12 configured for use in a transmission assembly having a sequential gearbox.

14. The main shaft bearing assembly of claim 1 configured for use in a transmission assembly having a sequential gearbox.
